(19) United States
(12) Patent Application Publication
(10) Pub. No.: US 2017/0318804 A1
(43) Pub. Date: Nov. 9, 2017

(54) PREPARATION AND DISPERSION OF STABLE EMULSION FORMULATIONS

(71) Applicant: AgroFresh Inc., Collegeville, PA (US)

(72) Inventor: Tirthankar GHOSH, Oreland, PA (US)

(21) Appl. No.: 15/499,082

(22) Filed: Apr. 27, 2017

Related U.S. Application Data
(60) Provisional application No. 62/331,705, filed on May 4, 2016.

(51) Int. Cl. A01N 25/04; A01N 27/00

(52) U.S. Cl. CPC A01N 25/04; A01N 27/00

(57) ABSTRACT

The present disclosure provides an aqueous-in-oil emulsion composition comprising an oil phase comprising an oil medium, wherein the oil phase is between 25-70% by weight of the composition; and an aqueous phase comprising i) a cyclopropene molecular encapsulating agent complex and ii) water. In addition, an aqueous-in-oil-in-aqueous double emulsion composition is provided comprising an aqueous-in-oil emulsion composition and a second aqueous phase, wherein the by weight % does not consider the second aqueous phase. Methods of making and using the compositions are also provided.

### CROSS-REFERENCE TO RELATED APPLICATION

This application claims the benefit under 35 U.S.C. §119(e) of U.S. Provisional Patent Application Ser. No. 62/331,705, filed on May 4, 2016, the entire disclosure of which is incorporated herein by reference.

### BACKGROUND OF THE INVENTION

Molecular encapsulating agents are known to control the delivery of volatile compounds such as cyclopropene. For example, 1-Methylcyclopropene (1-MCP) is a gas that is difficult to handle and store. Importantly, 1-MCP is also explosive above a concentration of 13,300 parts per million (ppm). As a result, in current agriculture applications, 1-MCP is usually stabilized into a clathrate such as α-cyclodextrin (alpha-cyclodextrin or α-CD) to ease handling during storage and transportation. The active ingredient 1-MCP is caged in α-CD, and the resulting crystalline complex is called a High Active Ingredient Product (HAIP). HAIP is typically composed of 100-150 micron (μm) needle-like crystals but can be air-milled to a fine powder if needed.

HAIP product can be stored for up to two years at ambient temperature inside a sealed container lined with a moisture barrier without loss of 1-MCP. Although the product is more convenient for the application than the 1-MCP gas itself, it still has some disadvantages. First, HAIP is in a powder form and is thus difficult to handle in the field or in an enclosed space. Furthermore, HAIP is water-sensitive, and releases 1-MCP gas completely within a short period of time when in contact with water. Upon contact with water or even moisture, 1-MCP gas will be quickly released at a rate which is not compatible with tank use as most of the gas will be lost in the tank headspace before the product has a chance to be sprayed in the field. Thus, stable liquid formulations that include encapsulated volatile compounds such as 1-MCP are highly desirable.

Cyclopropene compounds are also known to be useful for the treatment of plants and plant parts. However, current formulations of the cyclopropene compounds are limited by the low amounts active ingredient that may be included. Therefore, it is also highly desirable to develop formulations in which higher concentrations of cyclopropene active ingredients are achieved in order to more effectively administer the formulations to treat plants and plant parts.

Accordingly, the present disclosure provides aqueous-in-oil emulsion compositions and aqueous-in-oil-in-aqueous double emulsion compositions that have desirable properties and related advantages compared to other compositions known in the art. First, the compositions of the present disclosure provide an increase in active ingredient concentration compared to those currently available. Second, the aqueous-in-oil emulsion compositions of the present disclosure are able to be prepared by effectively separating the active ingredient upon mixing to ultimately provide a higher concentration of active ingredient in the composition. Third, the compositions of the present disclosure demonstrate an improved stability during storage, an ease of dilution in preparation for application, and an increased liberation of active ingredient upon application of the formulation. These combined benefits provide marked improvements over comparable compositions known in the art.

### SUMMARY OF THE INVENTION

Various embodiments of the invention are described herein as follows. In one aspect, an aqueous-in-oil emulsion composition is provided. The aqueous-in-oil emulsion composition comprises an oil phase comprising an oil medium, wherein the oil phase is between 25-70% by weight of the composition; and an aqueous phase comprising i) a cyclopropene molecular encapsulating agent complex and ii) water, wherein the aqueous phase is between 30-75% by weight of the composition; and wherein the water is between 0.5-20% by weight of the composition.

In another aspect, an aqueous-in-oil-in-aqueous double emulsion composition is provided. The aqueous-in-oil-in-aqueous double emulsion composition comprises an aqueous-in-oil emulsion composition as described herein and a second aqueous phase, wherein the by weight % does not consider the second aqueous phase.

In yet another aspect, a method for preparing an aqueous-in-oil emulsion composition is provided. The method comprises (a) combining an oil phase and an aqueous phase, (b) adding a cyclopropene molecular encapsulating agent complex to the combined oil phase and aqueous phase, and (c) mixing the combined oil phase and aqueous phase to form the aqueous-in-oil emulsion composition.

In another aspect, a method for preparing an aqueous-in-oil-in-aqueous double emulsion composition is provided. The method comprises (a) preparing an aqueous-in-oil primary emulsion by i) combining an oil phase and an aqueous phase, ii) adding a cyclopropene molecular encapsulating agent complex to the combined oil phase and aqueous phase, and iii) mixing the combined oil phase and aqueous phase to form the aqueous-in-oil primary emulsion; and (b) dispersing the aqueous-in-oil primary emulsion into a second aqueous phase using a hydrophilic emulsifier and a surfactant

In yet another aspect, a method of treating plants or plant parts is provided. The method comprises contacting the plants or plant parts with the aqueous-in-oil emulsion composition as described herein or with the aqueous-in-oil-in-aqueous double emulsion composition as described herein.

The following numbered embodiments are contemplated and are non-limiting:
1. An aqueous-in-oil emulsion composition, comprising
   (a) an oil phase comprising an oil medium, wherein the oil phase is between 25-70% by weight of the composition; and
   (b) an aqueous phase comprising i) a cyclopropene molecular encapsulating agent complex and ii) water, wherein the aqueous phase is between 30-75% by weight of the composition; and wherein the water is between 0.5-20% by weight of the composition.
2. The aqueous-in-oil emulsion composition of clause 1, wherein water is between about 0.5-6% by weight of the composition.
3. The aqueous-in-oil emulsion composition of clause 2, wherein the 0.5-6% by weight of water is present in the cyclopropene molecular encapsulating agent complex.
4. The aqueous-in-oil emulsion composition of clause 2 or clause 3, wherein no additional water is added to the aqueous-in-oil emulsion composition.
5. The aqueous-in-oil emulsion composition of any one of clauses 1 to 4, wherein the oil phase is between 40-70% by weight of the composition.
6. The aqueous-in-oil emulsion composition of any one of clauses 1 to 4, wherein the aqueous phase is between 30-60% by weight of the composition.
7. The aqueous-in-oil emulsion composition of any one of clauses 1 to 6, wherein the oil phase comprises a lipophilic emulsifier.
8. The aqueous-in-oil emulsion composition of clause 7, wherein the lipophilic emulsifier is between 1-10% by weight of the composition.
9. The aqueous-in-oil emulsion composition of clause 7, wherein the lipophilic emulsifier is selected from the group consisting of polyglycerol polyricinoleate, lecithin, sorbitan fatty esters, and combinations thereof.
10. The aqueous-in-oil emulsion composition of clause 7, wherein the lipophilic emulsifier is polyglycerol polyricinoleate.
11. The aqueous-in-oil emulsion composition of any one of clauses 1 to 10, wherein the oil phase comprises an oil soluble thickener.
12. The aqueous-in-oil emulsion composition of clause 11, wherein the oil soluble thickener is between 0.1-2% by weight of the composition.
13. The aqueous-in-oil emulsion composition of clause 11 or clause 12, wherein the oil soluble thickener is selected from the group consisting of natural rubber, polypropylene, polyisoprene, polybutadiene, styrene-ethylene-propylene block copolymer, poly(styrene-butadiene), poly(ethylene-propylene-diene), polyurethane, polymethacrylate, polyisobutylene, poly(isobutylene-succinic acid), poly(isobutylene-succinic acid-polyacrylamide), polyurea, polyethylene, and combinations thereof.
14. The aqueous-in-oil emulsion composition of clause 11 or clause 12, wherein the oil soluble thickener is a styrene-ethylene-propylene block copolymer.
15. The aqueous-in-oil emulsion composition of any one of clauses 1 to 14, wherein the oil phase comprises a lipophilic emulsifier and an oil soluble thickener.
16. The aqueous-in-oil emulsion composition of clause 15, wherein the lipophilic emulsifier is between 1-10% by weight of the composition and the oil soluble thickener is between 0.1-2% by weight of the composition.
17. The aqueous-in-oil emulsion composition of clause 15, wherein the lipophilic emulsifier is polyglycerol polyricinoleate and the oil soluble thickener is a styrene-ethylene-propylene block copolymer.
18. The aqueous-in-oil emulsion composition of any one of clauses 1 to 17, wherein the aqueous phase is substantially free of a salt.
19. The aqueous-in-oil emulsion composition of clause 18, wherein the salt is a non-deliquescent salt.
20. The aqueous-in-oil emulsion composition of clause 19, wherein the non-deliquescent salt comprises magnesium sulfate or ammonium sulfate.
21. The aqueous-in-oil emulsion composition of any one of clauses 1 to 20, wherein the aqueous phase comprises a salt.
22. The aqueous-in-oil emulsion composition of clause 21, wherein the water of the aqueous phase is between about 0.3-18% by weight of the composition and the salt of the aqueous phase is between about 0.2-8% by weight of the composition.
23. The aqueous-in-oil emulsion composition of clause 21 or clause 22, wherein the salt is a non-deliquescent salt.
24. The aqueous-in-oil emulsion composition of clause 22, wherein the non-deliquescent salt comprises magnesium sulfate or ammonium sulfate.
25. The aqueous-in-oil emulsion composition of any one of clauses 1 to 24, wherein the oil medium is selected from the group consisting of soybean oil, hydrogenated soybean oil, cotton seed oil, hydrogenated cotton seed oil, white mineral oil, hydrotreated middle petroleum distillate, hydrotreated light petroleum distillate, and combinations thereof.
26. The aqueous-in-oil emulsion composition of any one of clauses 1 to 25, wherein the cyclopropene is of the formula:

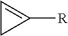

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.
27. The aqueous-in-oil emulsion composition of any one of clauses 1 to 26, wherein the cyclopropene is 1-methylcyclopropene (1-MCP).
28. The aqueous-in-oil emulsion composition of any one of clauses 1 to 27, wherein the molecular encapsulating agent is alpha-cyclodextrin.
29. The aqueous-in-oil emulsion composition of clause 27 or clause 28, wherein the aqueous-in-oil emulsion composition comprises between 1.2 and 3.3% 1-MCP by weight of the composition.
30. The aqueous-in-oil emulsion composition of clause 27 or clause 28, wherein the aqueous-in-oil emulsion composition comprises greater than 1.8% 1-MCP by weight of the composition.
31. The aqueous-in-oil emulsion composition of clause 27 or clause 28, wherein the aqueous-in-oil emulsion composition comprises greater than 2.0% 1-MCP by weight of the composition.
32. The aqueous-in-oil emulsion composition of clause 27 or clause 28, wherein the aqueous-in-oil emulsion composition comprises greater than 2.8% 1-MCP by weight of the composition.
33. The aqueous-in-oil emulsion composition of any one of clauses 27 to 32, wherein greater than 90% of 1-MCP is retained in the composition after 2 weeks at 54° C.
34. The aqueous-in-oil emulsion composition of any one of clauses 27 to 32, wherein greater than 95% of 1-MCP is retained in the composition after 2 weeks at 54° C.
35. An aqueous-in-oil-in-aqueous double emulsion composition, comprising:
   (a) the aqueous-in-oil emulsion composition of any one of clauses 1-34; and
   (b) a second aqueous phase;
      wherein the by weight % does not consider the second aqueous phase.
36. The aqueous-in-oil-in-aqueous double emulsion composition of clause 35, wherein the second aqueous phase comprises water.
37. The aqueous-in-oil-in-aqueous double emulsion composition of clause 35 or clause 36, wherein the second aqueous phase comprises a hydrophilic emulsifier.
38. The aqueous-in-oil-in-aqueous double emulsion composition of any one of clauses 35 to
37, wherein the hydrophilic emulsifier is selected from the group consisting of poly(vinyl alcohol), poly(acrylic acid), poly(acrylamide), sodium caseinate, whey protein isolate (WPI), polysaccharide, copolymers of ethylene glycol and propylene glycol (e.g. Pluronic), polyoxyethylene derivatives of sorbitan monolaureate (e.g. polysorbate 20, polysorbate 80) and combinations thereof.
39. The aqueous-in-oil-in-aqueous double emulsion composition of clause 37 or clause 38, wherein the hydrophilic emulsifier is hydroxyethyl cellulose.
40. The aqueous-in-oil-in-aqueous double emulsion composition of any one of clauses 35 to
39, wherein the second aqueous phase comprises a surfactant.
41. The aqueous-in-oil-in-aqueous double emulsion composition of clause 40, wherein the surfactant has a hydrophilic/lipophilic balance (HLB) of between 10-15.
42. The aqueous-in-oil-in-aqueous double emulsion composition of clause 40 or clause 41, wherein the surfactant has an HLB of about 12.
43. The aqueous-in-oil-in-aqueous double emulsion composition of clause 40 or clause 41, wherein the surfactant has an HLB of about 12.3.
44. The aqueous-in-oil-in-aqueous double emulsion composition of clause 40 or clause 41, wherein the surfactant has an HLB of about 13.
45. The aqueous-in-oil-in-aqueous double emulsion composition of clause 40 or clause 41, wherein the surfactant has an HLB of about 13.8.
46. The aqueous-in-oil-in-aqueous double emulsion composition of clause 40 or clause 41, wherein the surfactant has an HLB of about 14.
47. The aqueous-in-oil-in-aqueous double emulsion composition of clause 40 or clause 41, wherein the surfactant has an HLB of about 14.4.
48. The aqueous-in-oil-in-aqueous double emulsion composition of clause 40 or clause 41, wherein the surfactant has an HLB of about 15.
49. The aqueous-in-oil-in-aqueous double emulsion composition of any one of clauses 40 to
48, wherein the surfactant is an aqueous salt solution of a styrene-maleic anhydride copolymer.
50. The aqueous-in-oil-in-aqueous double emulsion composition of any one of clauses 40 to
48, wherein the surfactant is an aqueous salt solution of a partial ester of a styrene-maleic anhydride copolymer.
51. A method for preparing an aqueous-in-oil emulsion composition, said method comprising
   (a) combining an oil phase and an aqueous phase,
   (b) adding a cyclopropene molecular encapsulating agent complex to the combined oil phase and aqueous phase, and
   (c) mixing the combined oil phase and aqueous phase to form the aqueous-in-oil emulsion composition.
52. The method of clause 51 wherein the aqueous-in-oil emulsion composition is the aqueous-in-oil emulsion composition of any one of clauses 1 to 34.
53. A method for preparing an aqueous-in-oil-in-aqueous double emulsion composition, said method comprising:
   (a) preparing an aqueous-in-oil primary emulsion by
      i) combining an oil phase and an aqueous phase,
      ii) adding a cyclopropene molecular encapsulating agent complex to the combined oil phase and aqueous phase, and
      iii) mixing the combined oil phase and aqueous phase to form the aqueous-in-oil primary emulsion;
   (b) dispersing the aqueous-in-oil primary emulsion into a second aqueous phase using a hydrophilic emulsifier and a surfactant.
54. The method of clause 53 wherein the aqueous-in-oil-in-aqueous double emulsion composition is the aqueous-in-oil-in-aqueous double emulsion composition of any one of clauses 35 to 50.
55. A method of treating plants or plant parts, comprising contacting the plants or plant parts with either i) an aqueous-in-oil emulsion composition or ii) an aqueous-in-oil-in-aqueous double emulsion composition.
56. The method of clause 55 wherein the aqueous-in-oil emulsion composition is the aqueous-in-oil emulsion composition of any one of clauses 1 to 34.
57. The method of clause 55 wherein the aqueous-in-oil-in-aqueous double emulsion composition is the aqueous-in-oil-in-aqueous double emulsion composition of any one of clauses 35 to 50.

### DETAILED DESCRIPTION

In the present disclosure, an aqueous-in-oil emulsion composition is provided. The aqueous-in-oil emulsion composition comprises an oil phase comprising an oil medium, wherein the oil phase is between 25-70% by weight of the composition; and an aqueous phase comprising i) a cyclopropene molecular encapsulating agent complex and ii) water, wherein the aqueous phase is between 30-75% by weight of the composition; and wherein the water is between 0.5-20% by weight of the composition.

In various embodiments, the oil phase comprises an oil medium, wherein the oil phase is between 25-70% by weight of the composition. In some embodiments, the oil phase is between 40-70% by weight of the composition. As used herein, an “oil” is a compound that is liquid at 25° C. and 1 atmosphere pressure and that has a boiling point at 1 atmosphere pressure of 30° C. or higher. As used herein, the term “oil” optionally does not include water, optionally does not include surfactants (as described herein), and/or optionally does not include dispersants (as described herein).

In various embodiments, the aqueous phase comprises i) a cyclopropene molecular encapsulating agent complex and ii) water, wherein the aqueous phase is between 30-75% by weight of the composition; and wherein the water is between 0.5-20% by weight of the composition. In some embodiments, water is between about 0.5-6% by weight of the composition. In certain embodiments, the 0.5-6% by weight of water is present in the cyclopropene molecular encapsulating agent complex. For example, water may be present in the cyclopropene molecular encapsulating agent complex as water molecules or as a water-like species. In certain aspects, no additional water (other than that present in the cyclopropene molecular encapsulating agent complex) is added to the aqueous-in-oil emulsion composition. In some embodiments, the aqueous phase is between 30-60% by weight of the composition.

In various embodiments, the oil phase comprises a lipophilic emulsifier. As used herein, the term “lipophilic emulsifier” refers to an emulsifier that is soluble in the oils described in the present disclosure. In certain aspects, the lipophilic emulsifier is between 1-10% by weight of the composition. In some embodiments, the lipophilic emulsifier is selected from the group consisting of polyglycerol polyricinoleate, lecithin, sorbitan fatty esters, and combinations thereof. In one embodiment, the lipophilic emulsifier is polyglycerol polyricinoleate (PGPR). In another embodiment, the lipophilic emulsifier is lecithin. In yet another embodiment, the lipophilic emulsifier is a sorbitan fatty ester (e.g., Span 80).

In various embodiments, the oil phase comprises an oil soluble thickener. In certain aspects, the oil soluble thickener is between 0.1-2% by weight of the composition. In some embodiments, the oil soluble thickener is selected from the group consisting of natural rubber, polypropylene, polyisoprene, polybutadiene, styrene-ethylene-propylene block copolymer, poly(styrene-butadiene), poly(ethylene-propylene-diene), polyurethane, polymethacrylate, polyisobutylene, poly(isobutylene-succinic acid), poly(isobutylene-succinic acid-polyacrylamide), polyurea, polyethylene, and combinations thereof. In one embodiment, the oil soluble thickener is natural rubber. In another embodiment, the oil soluble thickener is polypropylene. In yet another embodiment, the oil soluble thickener is polyisoprene, In one embodiment, the oil soluble thickener is polybutadiene. In another embodiment, the oil soluble thickener is styrene-ethylene-propylene block copolymer. In yet another embodiment, the oil soluble thickener is poly(styrene-butadiene). In one embodiment, the oil soluble thickener is poly(ethylene-propylene-diene). In another embodiment, the oil soluble thickener is polyurethane. In yet another embodiment, the oil soluble thickener is polymethacrylate. In one embodiment, the oil soluble thickener is polyisobutylene. In another embodiment, the oil soluble thickener is poly(isobutylene-succinic acid). In yet another embodiment, the oil soluble thickener is poly(isobutylene-succinic acid-polyacrylamide). In one embodiment, the oil soluble thickener is polyuria. In another embodiment, the oil soluble thickener is polyethylene. In some embodiments, the oil soluble thickener comprises a higher molecular weight component and a lower molecular weight component, characterized in that the thickener comprises a mixture of (1) a (co- or homo)polymer of propylene with a weight average molecular weight of more than 200,000 and (2) a (co- or homo)polymer of propylene with a weight average molecular weight of less than 200,000.

In various embodiments, the oil phase comprises a lipophilic emulsifier and an oil soluble thickener. In certain aspects, the lipophilic emulsifier is between 1-10% by weight of the composition and the oil soluble thickener is between 0.1-2% by weight of the composition. In other aspects, the lipophilic emulsifier is polyglycerol polyricinoleate and the oil soluble thickener is a styrene-ethylene-propylene block copolymer.

In some embodiments, the aqueous phase comprises a salt. As used herein, a “salt” refers to an ionic compound comprising at least one anion and at least one cation. A salt may be present as an ionic solid or as a solution in water. Some suitable anions are, for example, the anion residues of acids that have pKa values of 5 or lower. Some suitable salts, for example, are compounds that, regardless of the method used to actually make them, have the structure of a compound that would be formed by substituting a cation that is not a hydrogen ion for the hydrogen ion in an acid that has a pKa of 5 or lower; an acid that has a pKa of 2.5 or lower; or an acid that has a pKa of 1.0 or lower.

In some embodiments, one or more salt is used that is suitable for treating agricultural plants. Independently, in some embodiments, one or more salt is used that has solubility in water at 25° C. at 1 atmosphere pressure, per 100 mL of water, of 1 gram or more, or 3 grams or more, or 10 grams or more, or 20 grams or more, or 30 grams or more.

Some non-limiting examples of suitable anions are these: acetate, chloride, nitrate, phosphate, or sulfate. Independently, some non-limiting examples of suitable cations are, for example, ammonium, calcium, magnesium, manganese, potassium, or sodium. It is contemplated that suitable cations and suitable anions may be used in any combination or mixture, with the provision that at least one salt is used that is not calcium chloride.

In some embodiments, no appreciable amount of calcium chloride is present in the composition of the present invention. It is contemplated that a finite but non-appreciable amount of calcium chloride may be present in a composition of the present invention (for example, because of one or more impurities). Calcium chloride may be present with a ratio of dry weight of calcium chloride to dry weight of total salt of 0.03 or less; or 0.01 or less; or 0.003 or less; or 0.001 or less; or zero.

In some embodiments, one or more salt is used that is selected from ammonium acetate, ammonium chloride, ammonium nitrate, ammonium phosphate, ammonium sulfate, calcium acetate, magnesium acetate, magnesium chloride, magnesium sulfate, manganese nitrate, potassium acetate, potassium chloride, potassium phosphate, potassium sulfate, sodium acetate, sodium chloride, sodium phosphate, or sodium sulfate. In some embodiments, one or more salt is used that is selected from ammonium acetate, ammonium chloride, ammonium sulfate, magnesium acetate, magnesium chloride, magnesium sulfate, potassium acetate, potassium chloride, potassium phosphate, sodium acetate, sodium chloride, disodium phosphate, or sodium sulfate. In some embodiments, one or more salt is used that is selected from ammonium chloride, ammonium sulfate, magnesium sulfate, sodium acetate, sodium chloride, disodium phosphate, or sodium sulfate. Mixtures of suitable salts are also suitable.

In some embodiments, one or more sulfate salt is used. Independently, in some embodiments, no chloride salt is used.

In some embodiments, the salt is a non-deliquescent salt. A non-deliquescent salt is a salt that is not a deliquescent salt. A deliquescent salt is a salt that, in its solid form, readily absorbs large amounts of water from the atmosphere. At 25° C. and 1 atmosphere pressure, if relative humidity is not zero, a deliquescent salt will absorb sufficient water from the atmosphere to form a liquid solution. Some known deliquescent salts are, for example, ammonium formate; calcium chloride; magnesium chloride; potassium phosphate, monobasic; and potassium phosphate, dibasic. Some embodiments of the present disclosure do not contain appreciable amounts of any deliquescent salt. It is contemplated that a finite but non-appreciable amount of deliquescent salt may be present in an embodiment of the present invention (for example, because of one or more impurities). Deliquescent salt may be present in a ratio of dry weight of deliquescent salt to dry weight of total salt of 0.01 or lower; or 0.001 or lower; or zero. In other embodiments, the non-deliquescent salt comprises magnesium sulfate or ammonium sulfate. In certain embodiments, the water of the aqueous phase is between about 0.3-18% by weight of the composition and the salt of the aqueous phase is between about 0.2-8% by weight of the composition.

In certain embodiments, the aqueous phase is substantially free of a salt. As used herein, the term “substantially free” includes a non-appreciable amount of salt that may be present in a composition of the present invention (for example, because of one or more impurities). In some embodiments, the salt is a non-deliquescent salt. In other embodiments, the non-deliquescent salt comprises magnesium sulfate or ammonium sulfate.

In some embodiments, one or more oil may be used that has boiling point of 50° C. or higher; or 75° C. or higher; or 100° C. or higher. In some embodiments, the oil used has boiling point of 50° C. or higher. In some embodiments, the oil used has boiling point of 75° C. or higher. In some embodiments, the oil used has boiling point of 100° C. or higher. Independently, in some of the embodiments that use oil, one or more oil may be used that has an average molecular weight of 100 or higher; or 200 or higher; or 500 or higher. In some embodiments, the oil used has an average molecular weight of 100 or higher. In some embodiments, the oil used has an average molecular weight of 200 or higher. In some embodiments, the oil used has an average molecular weight of 500 or higher.

An oil may be either a hydrocarbon oil (i.e., an oil whose molecule contains only atoms of carbon and hydrogen) or a non-hydrocarbon oil (i.e., an oil whose molecule contains at least at least one atom that is neither carbon nor hydrogen).

Some suitable hydrocarbon oils are, for example, straight, branched, or cyclic alkane compounds with 6 or more carbon atoms. Some other suitable hydrocarbon oils, for example, have one or more carbon-carbon double bond, one or more carbon-carbon triple bond, or one or more aromatic ring, possibly in combination with each other and/or in combination with one or more alkane group. Some suitable hydrocarbon oils are obtained from petroleum distillation and contain a mixture of compounds, along with, in some cases, impurities. Hydrocarbon oils obtained from petroleum distillation may contain a relatively wide mixture of compositions or may contain relatively pure compositions. In some embodiments, hydrocarbon oils are used that contain 6 or more carbon atoms. In some embodiments, hydrocarbon oils are used that contain 18 or fewer carbon atoms. In some embodiments, every hydrocarbon oil that is used contains 18 or fewer carbon atoms. In some embodiments, every hydrocarbon oil that is used contains 6 or more carbon atoms. Some suitable hydrocarbon oils include, for example, hexane, decane, dodecane, hexadecane, diesel oil, hydrotreated light petroleum distillates, hydrotreated medium petroleum distillates, refined paraffinic oil (e.g., Ultrafine™ spray oil from Sun Company), and mixtures thereof. In some embodiments, the oil used is a hydrocarbon oil.

Among embodiments that use non-hydrocarbon oil, some suitable non-hydrocarbon oils are, for example, fatty non-hydrocarbon oils. “Fatty” means herein any compound that contains one or more residues of fatty acid. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups, which are either naturally occurring or that have been added. Some suitable fatty non-hydrocarbon oils are, for example, fatty acids; esters of fatty acids; amides of fatty acids; dimers, trimers, oligomers, or polymers thereof; and mixtures thereof.

Some of the suitable fatty non-hydrocarbon oils are, for example, esters of fatty acids. Such esters include, for example, glycerides of fatty acids. Glycerides are esters of fatty acids with glycerol, and they may be mono-, di-, or triglycerides. A variety of triglycerides are found in nature. Most of the naturally occurring triglycerides contain residues of fatty acids of several different lengths and/or compositions. Some suitable triglycerides are found in animal sources such as, for example, dairy products, animal fats, or fish. Further examples of suitable triglycerides are oils found in plants, such as, for example, coconut, palm, cottonseed, olive, tall, peanut, safflower, sunflower, corn, soybean, linseed, tung, castor, canola, citrus seed, cocoa, oat, palm, palm kernel, rice bran, cuphea, or rapeseed oil.

Among the suitable triglycerides, independent of where they are found, are those, for example, that contain at least one fatty acid residue that has 14 or more carbon atoms. Some suitable triglycerides have fatty acid residues that contain 50% or more by weight, based on the weight of the residues, fatty acid residues with 14 or more carbon atoms, or 16 or more carbon atoms, or 18 or more carbon atoms. One example of a suitable triglyceride is soybean oil.

Suitable fatty non-hydrocarbon oils may be synthetic or natural or modifications of natural oils or a combination or mixture thereof. Among suitable modifications of natural oils are, for example, alkylation, hydrogenation, hydroxylation, alkyl hydroxylation, alcoholysis, hydrolysis, epoxidation, halogenation, sulfonation, oxidation, polymerization, and combinations thereof. In some embodiments, alkylated (including, for example, methylated and ethylated) oils are used. One suitable modified natural oil is methylated soybean oil.

Also among the suitable fatty non-hydrocarbon oils are self-emulsifying esters of fatty acids.

Another group of suitable non-hydrocarbon oils is the group of silicone oils. Silicone oil is an oligomer or polymer that has a backbone that is partially or fully made up of —Si—O—links. Silicone oils include, for example, polydimethylsiloxane oils. Polydimethylsiloxane oils are oligomers or polymers that contain units of the form

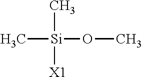

where at least one of the units has X1=CH₃. In other units, X1 may be any other group capable of attaching to Si, including, for example, hydrogen, hydroxyl, alkyl, alkoxy, hydroxyalkyl, hydroxyalkoxy, alkylpolyalkoxyl, substituted versions thereof, or combinations thereof. Substituents may include, for example, hydroxyl, alkoxyl, polyethoxyl, ether linkages, ester linkages, amide linkages, other substituents, or any combination thereof. In some embodiments, the oil used is a silicone oil.

In some suitable polydimethylsiloxane oils, all X1 groups are groups that are not hydrophilic. In some suitable polydimethylsiloxane oils, all X1 groups are alkyl groups. In some suitable polydimethylsiloxane oils, all X1 groups are methyl. In some embodiments, every silicone oil is a polydimethylsiloxane oil in which all X1 groups are methyl. In some suitable polydimethylsiloxanes, at least one unit has an X1 group that is not methyl; if more than one non-methyl X1 unit is present, the non-methyl X1 units may be the same as each other, or two or more different non-methyl X1 units may be present. Polydimethylsiloxane oils may be end-capped with any of a wide variety of chemical groups, including, for example, hydrogen, methyl, other alkyl, or any combination thereof. Also contemplated are cyclic polydimethylsiloxane oils. Mixtures of suitable oils are also suitable.

In some embodiments, the oil medium is selected from the group consisting of soybean oil, hydrogenated soybean oil, cotton seed oil, hydrogenated cotton seed oil, white mineral oil, hydrotreated middle petroleum distillate, hydrotreated light petroleum distillate, and combinations thereof. In one embodiment, the oil medium is soybean oil. In another embodiment, the oil medium is hydrogenated soybean oil. In yet another embodiment, the oil medium is cotton seed oil. In one embodiment, the oil medium is hydrogenated cotton seed oil. In another embodiment, the oil medium is white mineral oil. In yet another embodiment, the oil medium is hydrotreated middle petroleum distillate. In one embodiment, the oil medium is hydrotreated light petroleum distillate. In a further embodiment, the white mineral oil comprises Blandol and/or Klearol. In another further embodiment, the hydrotreated middle petroleum distillate comprises Conosol 260, Unipar SH 260 CC, and/or Isopar V. In another further embodiment, the hydrotreated light petroleum distillate comprises Unipar SH 210 AS and/or Isopar M.

The practice of the present invention optionally involves the use of one or more cyclopropene compound. As used herein, a cyclopropene compound is any compound with the formula

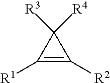

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of a C₁-C₈ alkyl, hydrogen, halo, cyano, nitro, nitroso, azido, chlorate, bromate, iodate, isocyanato, isocyanido, isothiocyanato, pentafluorothio, and a chemical group G, wherein G is a 3- to 14-membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylamino sulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorate, bromate, iodate, isocyanato, isocyanido, isothiocyanato, pentafluorothio, acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl, and substituted analogs thereof.

As used herein, the chemical group G is a 3- to 14-membered ring system. Ring systems suitable as chemical group G may be substituted or unsubstituted; they may be aromatic (including, for example, phenyl and naphthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or C₁-C₁₀ alkyl. In another embodiment, each of R¹, R², R³, and R⁴ is hydrogen or a C₁-C₈ alkyl. In another embodiment, each of R¹, R², R³, and R⁴ is hydrogen or C₁-C₄ alkyl. In another embodiment, each of R¹, R², R³, and R⁴ is hydrogen or methyl. In another embodiment, R¹ is C₁-C₄ alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In various embodiments, the cyclopropene is of the formula:

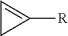

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁-C₈ alkyl. In another embodiment, R is methyl.

In another embodiment, the cyclopropene is of the formula:

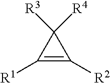

wherein R¹ is a substituted or unsubstituted C₁-C₄ alkyl, C₂-C₄ alkenyl, C₂-C₄ alkynyl, C₃-C₆ cycloalkyl, cycloalkylalkyl, phenyl, or naphthyl group; and R², R³, and R⁴ are hydrogen. In another embodiment, the cyclopropene comprises 1-methylcyclopropene (1-MCP).

In one embodiment, the cyclopropene comprises 1-methylcyclopropene (1-MCP). In another embodiment, the molecular encapsulating agent is selected from the group consisting of substituted cyclodextrins, unsubstituted cyclodextrins, and combinations thereof. In a further embodiment, the molecular encapsulating agent comprises alpha-cyclodextrin.

In some embodiments, a cyclopropene is used that has boiling point at one atmosphere pressure of 50° C. or lower; 25° C. or lower; or 15° C. or lower. Independently, in some embodiments, a cyclopropene is used that has boiling point at one atmosphere pressure of −100° C. or higher; −50° C. or higher; −25° C. or higher; or 0° C. or higher.

The cyclopropenes applicable to this invention may be prepared by any method. Some suitable methods of preparation of cyclopropenes are the processes disclosed in U.S. Pat. Nos. 5,518,988 and 6,017,849.

In some embodiments, at least one molecular encapsulating agent is used to encapsulate at least one volatile compound. In some embodiments, at least one molecular encapsulating agent encapsulates one or more cyclopropene or a portion of one or more cyclopropene. A complex that contains a cyclopropene molecule or a portion of a cyclopropene molecule encapsulated in a molecule of a molecular encapsulating agent is known herein as a “cyclopropene molecular encapsulating agent complex.”

In some embodiments, at least one cyclopropene molecular encapsulating agent complex forms an inclusion complex. In such an inclusion complex, the molecular encapsulating agent forms a cavity, and the cyclopropene or a portion of the cyclopropene is located within that cavity. In some of such inclusion complexes, there is no covalent bonding between the cyclopropene and the molecular encapsulating agent. Independently, in some of such inclusion complexes, there is no ionic bonding between the cyclopropene and the molecular encapsulating complex, whether or not there is any electrostatic attraction between one or more polar moiety in the cyclopropene and one or more polar moiety in the molecular encapsulating agent.

In some embodiments of the inclusion complexes, the interior of the cavity of the molecular encapsulating agent is substantially apolar or hydrophobic or both, and the cyclopropene (or the portion of the cyclopropene located within that cavity) is also substantially apolar or hydrophobic or both. While the present invention is not limited to any particular theory or mechanism, it is contemplated that, in such apolar cyclopropene molecular encapsulating agent complexes, van der Waals forces, or hydrophobic interactions, or both, cause the cyclopropene molecule or portion thereof to remain within the cavity of the molecular encapsulating agent.

The cyclopropene molecular encapsulation agent complexes can be prepared by various means. For one example, such complexes are prepared by contacting the cyclopropene with a solution or slurry of the molecular encapsulation agent and then isolating the complex, using processes disclosed in U.S. Pat. No. 6,017,849. For another example, in one method of making a complex in which 1-MCP is encapsulated in a molecular encapsulating agent, the 1-MCP gas is bubbled through a solution of alpha-cyclodextrin in water, from which the complex first precipitates and is then isolated by filtration. In some embodiments, complexes are made by the above method and, after isolation, are dried and stored in solid form, for example as a powder, for later addition to useful compositions.

The amount of molecular encapsulating agent can usefully be characterized by the ratio of moles of molecular encapsulating agent to moles of cyclopropene. In some embodiments, the ratio of moles of molecular encapsulating agent to moles of cyclopropene is 0.1 or larger; 0.2 or larger; 0.5 or larger; or 0.9 or larger. In some embodiments, the ratio of moles of molecular encapsulating agent to moles of cyclopropene is 2.0 or lower; 1.5 or lower; or 1.0 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In some embodiments of the invention, the encapsulating agent is alpha-cyclodextrin, beta-cyclodextrin, gamma-cyclodextrin, or a mixture thereof. In some embodiments of the invention, alpha-cyclodextrin is used. The preferred encapsulating agent will vary depending upon the structure of the cyclopropene or cyclopropenes being used. A particular cyclodextrin or mixture of cyclodextrins, cyclodextrin polymers, modified cyclodextrins, or mixtures thereof can also be used.

In one embodiment, the aqueous-in-oil emulsion composition comprises between 1.2 and 3.3% 1-MCP by weight of the composition. In another embodiment, the aqueous-in-oil emulsion composition comprises greater than 1.8% 1-MCP by weight of the composition. In yet another embodiment, the aqueous-in-oil emulsion composition comprises greater than 2.0% 1-MCP by weight of the composition. In another embodiment, the aqueous-in-oil emulsion composition comprises greater than 2.8% 1-MCP by weight of the composition.

In certain aspects, the aqueous-in-oil emulsion composition is a stable composition. As used herein, the term “stable” refer to cyclopropene content at ambient temperature over time, for example after one (1) year, in a solution with no more than 15% loss as compared to day zero (0). Alternatively, the solution may be tested at 54° C. with no more than 15% loss over a period of time, for example one week or four weeks. When the cyclopropene content is maintained over a period of time, the solution is a “stable” cyclopropene formulation or cyclopropene solution. In some embodiments, greater than 90% of 1-MCP is retained in the composition after 2 weeks at 54° C. In other embodiments, greater than 95% of 1-MCP is retained in the composition after 2 weeks at 54° C.

In some embodiments, a composition of the present disclosure may be stored for later use. Compositions of the present disclosure may be stored in any form. In some embodiments, the composition of the present disclosure may be stored in a sealed container. A sealed container is one that is constructed so that no effective amount of material (solid, liquid, or gas) passes in or out of the container. Independent of the type of container used, compositions of the present invention may be stored for 3 hours or longer; or 8 hours or longer; or 1 day or longer; or 1 week or longer; or 3 weeks or longer; or 2 months or longer; or 6 months or longer.

In another aspect, an aqueous-in-oil-in-aqueous double emulsion composition is provided. The aqueous-in-oil-in-aqueous double emulsion composition comprises an aqueous-in-oil emulsion composition as described herein and a second aqueous phase, wherein the by weight % does not consider the second aqueous phase. Due to its unexpected stability, the aqueous-in-oil-in-aqueous double emulsion composition disclosed can also be used as a stock solution or concentrated solution to be further diluted with water as sprayable or oral formulations. The aqueous-in-oil-in-aqueous double emulsion composition is a compartmented structure consisting of small aqueous droplets embedded within larger oil droplets, which themselves are dispersed within an external aqueous phase. The aqueous-in-oil-in-aqueous double emulsion composition may have at least one of the following advantages: (a) high capacity of entrapment of hydrophilic compounds; (b) ability to introduce incompatible substances into the same system; (c) performance improvement of active compounds; and (d) protection and sustained release of chemical substances initially entrapped in the internal droplets.

In certain embodiments, the second aqueous phase comprises water. In certain aspects, the second aqueous phase comprises a hydrophilic emulsifier. In various aspects, the hydrophilic emulsifier is selected from the group consisting of poly(vinyl alcohol), poly(acrylic acid), poly(acrylamide), sodium caseinate, whey protein isolate (WPI), polysaccharide, copolymers of ethylene glycol and propylene glycol (e.g. Pluronic), polyoxyethylene derivatives of sorbitan monolaureate (e.g. polysorbate 20, polysorbate 80) and combinations thereof.

In one embodiment, the hydrophilic emulsifier is poly(vinyl alcohol). In another embodiment, the hydrophilic emulsifier is poly(acrylic acid). In yet another embodiment, the hydrophilic emulsifier is poly(acrylamide). In one embodiment, the hydrophilic emulsifier is sodium caseinate. In another embodiment, the hydrophilic emulsifier is whey protein isolate (WPI). In yet another embodiment, the hydrophilic emulsifier is polysaccharide. In one embodiment, the hydrophilic emulsifier is a copolymer of ethylene glycol and propylene glycol (e.g. Pluronic). In another embodiment, the hydrophilic emulsifier is a polyoxyethylene derivative of sorbitan monolaureate (e.g. polysorbate 20, polysorbate 80). In yet another embodiment, the hydrophilic emulsifier is hydroxyethyl cellulose.

In some embodiments, the second aqueous phase comprises a surfactant. In certain aspects, the surfactant has a hydrophilic/lipophilic balance (HLB) of between 10-15. As known in the art, a hydrophilic/lipophilic balance refers to a measure of the degree to which a surfactant is hydrophilic or lipophilic. In one embodiment, the surfactant has an HLB of about 12. In another embodiment, the surfactant has an HLB of about 12.3. In yet another embodiment, the surfactant has an HLB of about 13. In one embodiment, the surfactant has an HLB of about 13.8. In another embodiment, the surfactant has an HLB of about 14. In another embodiment, the surfactant has an HLB of about 14.4. In another embodiment, the surfactant has an HLB of about 15.

In certain aspects, the surfactant is an aqueous salt solution of a styrene-maleic anhydride copolymer. In other aspects, the surfactant is an aqueous salt solution of a partial ester of a styrene-maleic anhydride copolymer.

In yet another aspect, a method for preparing an aqueous-in-oil emulsion composition is provided. The method comprises (a) combining an oil phase and an aqueous phase, (b) adding a cyclopropene molecular encapsulating agent complex to the combined oil phase and aqueous phase, and (c) mixing the combined oil phase and aqueous phase to form the aqueous-in-oil emulsion composition. The embodiments describing the aqueous-in-oil emulsion compositions provided herein are also applicable to the method for preparing an aqueous-in-oil emulsion composition.

In another aspect, a method for preparing an aqueous-in-oil-in-aqueous double emulsion composition is provided. The method comprises (a) preparing an aqueous-in-oil primary emulsion by i) combining an oil phase and an aqueous phase, ii) adding a cyclopropene molecular encapsulating agent complex to the combined oil phase and aqueous phase, and iii) mixing the combined oil phase and aqueous phase to form the aqueous-in-oil primary emulsion; and (b) dispersing the aqueous-in-oil primary emulsion into a second aqueous phase using a hydrophilic emulsifier and a surfactant. The embodiments describing the aqueous-in-oil-in-aqueous double emulsion compositions provided herein are also applicable to the method for preparing an aqueous-in-oil-in-aqueous double emulsion composition. In one embodiment, the method further comprises diluting the composition with a solvent. In a further embodiment, the solvent comprises water.

In yet another aspect, a method of treating plants or plant parts is provided. The method comprises contacting the plants or plant parts with the aqueous-in-oil emulsion composition as described herein or with the aqueous-in-oil-in-aqueous double emulsion composition as described herein. As used herein, the term “treating” a plant or plant part refers to bringing the plant or plant part into contact with a material. The plants that are treated may be any plants that produce a useful product, and the plant parts that are treated may be any part of the plant that produces a useful product.

In embodiments of the present invention in which a plant or plant part is treated, a composition of the present disclosure is used in a way that brings cyclopropene into contact with the plant or plant part. In some embodiments, the method involves using a composition of the present disclosure in a way that releases cyclopropene from the cyclopropene molecular encapsulating agent complex under conditions in which the cyclopropene then comes into contact with the plant or plant part.

For example, an embodiment of the composition of the present disclosure may be used in a process that brings cyclopropene into contact with plants or plant parts. Such contact may be performed in any of a wide variety of ways. For example, an embodiment of the composition of the present disclosure is placed in a closed space (such as, for example, a transportation trailer or a controlled-atmosphere room) along with plants or plant parts, and operations are performed on the composition to promote the release of cyclopropene from the composition into the atmosphere of the closed space. Operations that promote the release of cyclopropene from the composition include, for example, introducing gas bubbles into the composition.

In another example, an embodiment of the composition of the present disclosure may be placed in a closed space along with plants or plant parts, operations may be performed on the composition to promote the release of cyclopropene from the composition into the atmosphere of the closed space. Operations that promote the release of cyclopropene from the composition include, for example, contacting the composition of the present disclosure with water or with a high-humidity atmosphere.

In some embodiments, the practice of the present disclosure involves bringing the cyclopropene molecular encapsulating agent complex into contact with the plant or plant part. While the present disclosure is not limited to any particular theory or mechanism, it is contemplated that, in embodiments in which a cyclopropene molecular encapsulating agent complex is brought into contact with a plant or plant part, some or all of the cyclopropene subsequently departs from the molecular encapsulating agent and, possibly after a diffusion process, comes into direct contact with the plant or plant part.

For example, an embodiment of the composition of the present disclosure may be brought into contact with plants or plant parts directly. Some examples of methods of such contact are, for example, spraying, foaming, fogging, pouring, brushing, dipping, similar methods, and combinations thereof. In some embodiments, spraying or dipping or both is used. In some embodiments, spraying is used. Such contact may be performed indoors or outdoors. In some of such embodiments, contact is performed on all or part of a plant while it is growing in a field (i.e., outdoor applications). It is contemplated that the compositions provided in the present disclosure can be mixed with water in a spray tank for indoor and/or outdoor (open field) applications.

Normally, a specific part of the plant forms the useful product. A plurality of useful plant parts, after removal from a plurality of plants, is known as a “crop.” Some types of plants have a single type of useful plant part, while other types of plants have plural types of useful plant parts.

Among the plants and plant parts that are suitable for use according to the present disclosure are, for example, plants (and parts thereof) with plant parts that are edible, plants (and parts thereof) with plant parts that are non-edible but useful for some other purpose, and combinations thereof. Also contemplated as suitable plants (and parts thereof) are those from which useful materials can be extracted; such useful materials may be, for example, edible materials, raw materials for manufacturing, medicinally useful materials, and materials useful for other purposes.

Further contemplated as suitable plants (and parts thereof) are those that yield plant parts that are useful for their beauty and/or ornamental properties. Such ornamental plant parts include, for example, flowers and other ornamental plant parts such as, for example, ornamental leaves. Some of such plants produce useful bulbs. In some embodiments, an entire ornamental plant is considered to be the useful plant part.

Plants that produce all types of edible plant parts are contemplated as suitable for use in the present invention. Also suitable are all types of edible plant parts.

Many of the plants (and parts thereof) that are suitable for use in the practice of the present invention can be usefully divided into categories or groups. One useful method for defining such groups is the “Definition and Classification of Commodities,” published on or before Mar. 23, 2006, by the Food and Agriculture Organization (“FAO”) of the United Nations as a “Draft.” In the practice of some embodiments of the present invention, it is contemplated to treat plants that produce one or more crops that fall within any of the crop groups defined by the FAO. In some embodiments, it is contemplated to treat one or more crops that fall within one or more of those groups.

Those skilled in the art would understand certain variations can exist based on the disclosure provided. Thus, the following examples are given for the purpose of illustrating the invention and shall not be construed as being a limitation on the scope of the invention or claims

### EXAMPLES

### Example 1

### General Preparation Procedures

Generally, the oil phase of the aqueous-in-oil emulsion composition can be prepared as follows. First, Isopar V is heated to 85° C. while stirring. Kraton G 1702 is added and stirred at 85° C. for one hour. The combination is then cooled to 40° C., and Palsgaard 4125 is added and stirred until it reaches room temperature.

Various oil phases can be prepared in this manner. Some exemplary oil phases are provided in Table 1.

TABLE 1

| Oil phase | Palsgaard PGPR 4125 | |
|---|---|---|
| designation | (%) | Kraton G1702 (%) |
| OP-1 | 4 | 0.75 |
| OP-2 | 6 | 0.75 |
| OP-3 | 6 | 1.5 |
| OP-4 | 8 | 1.5 |
| OP-5 | 6 | 0 |

Generally, the aqueous phase of the aqueous-in-oil emulsion composition can be prepared as follows. First, 44.9% MgSO₄.7H₂O (magnesium sulfate heptahydrate) and 0.5% EDTA (Dissolvene 220S) are added to 54.6% Milli Q water and stirred at room temperature until dissolved.

For the following examples, a high active ingredient product (i.e., “HAIP”) refers to a product comprising a complex of 1-MCP and α-cyclodextrin. The concentration of 1-MCP in the complex can varies from about 4.2% to about 5.0%. HAIP can be formulated as a powder, for example a powder milled to an average particle size of about 6μ.

### Example 2

### Preparation of Aqueous-in-Oil Emulsion Compositions with HAIP

A predetermined amount of the oil phase can be mixed with an Ultra Turrax IKA (set at 2.5) and an amount of the aqueous phase is then combined with the oil phase. The speed of the IKA can be increased to 5, and the HAIP can be added slowly over about 5 minutes. The IKA blade can be positioned at the top of the combination when the HAIP is added, which provides sufficient combination of the HAIP and prevents clumping. The speed can be decreased to a setting of 2.5. The temperature during the mixing process is preferably kept below 40° C.

### Example 3

### Measurement of Concentration and Stability of Aqueous-in-Oil Emulsion Compositions

The amount of 1-MCP in the aqueous-in-oil emulsion composition can be measured as follows. Approximately 3 ml of a solution containing 1% blue dawn dishwashing soap and 0.1% Silwet L-77 in Milli Q water can be added to a 122 ml headspace bottle. Thereafter, 0.017 g to 0.03 g of the formulation can be weighed and added to the bottle and capped immediately. The bottles can be swirled on a rotator for about 1 hour, then the headspace can be sampled and the 1-MCP concentration is determined by gas chromatography (GC) analysis. The analysis is done in triplicate and the average value can be reported.

The amount of 1-MCP in the headspace of an aqueous-in-oil emulsion composition sample can be measured as follows. A 122 ml headspace bottle can be half filled (approximately 60 grams) with the formulation and sealed with a mininert valve. Samples of the headspace can then be obtained at predetermined time intervals and the 1-MCP concentration can be determined by GC analysis.

The chemical stability of aqueous-in-oil emulsion composition samples can be determined as follows. A glass bottle can be filled to ˜80% full with the sample being tested. The sample is then placed in a 54° C. oven for about 2 weeks. The sample is subsequently removed and cooled to room temperature. The sample is then shaken and stirred to ensure homogeneity and analyzed by GC to determine 1-MCP content. A sample of the original room temperature formulation can also be analyzed by GC at the same time.

Approximately 3 ml of a solution containing 1% dishwashing soap and 0.1% Silwet L-77 in Milli-Q® water can be added to a 122 ml headspace bottle. The formulation can be weighed (0.0170 g to 0.0300 g) into the bottle and capped immediately. The bottle can be swirled on a rotator for 1 hour and analyzed by GC. The analysis is done in triplicate and the average value can be reported.

The physical stability of aqueous-in-oil emulsion composition samples can be determined as follows. Approximately 40 ml of the sample can be poured into a 50 ml self-standing centrifuge tube with a plug and seal cap. The tube can be labeled and placed into a tube stand for support. After 4 weeks, the phase stability can be determined by measuring the height (in mm) of the clear phase that separates on the top of the sample.

Table 2 shows the measured 1-MCP concentrations and stability values of the various aqueous-in-oil emulsion compositions.

TABLE 2

| | | | | | | % 1-MCP | | | |
|---|---|---|---|---|---|---|---|---|---|
| | | Oil | Water | | | retained after | 1-MCP in | | |
| | Type of | phase | phase | HAIP | 1-MCP | 2 weeks at | headspace (ppm) | | Phase |
| Example | Oil phase | (%) | (%) | (%) | (%) | 54° C. | 1 hour | 3 hour | stability |
| BMS-7909D | OP-1 | 50 | 20 | 30 | 1.2 | 69 | 2626 | 2560 | |
| BMS-7912 | OP-1 | 45 | 19 | 36 | 1.5 | 87 | 1672 | 2560 | |
| BMS-7917 | OP-2 | 50 | 20 | 30 | 1.2 | 89 | 1508 | 1390 | |
| BMS-7918 | OP-2 | 50 | 17 | 33 | 1.4 | 94 | 1211 | 1161 | |
| BMS-7922 | OP-2 | 50 | 12 | 38 | 1.6 | 88 | 1525 | 1478 | |
| BMS-7929 | OP-2 | 50 | 8 | 42 | 1.8 | 89 | | | 17 mm |
| BMS-2930 | OP-5 | 50 | 8 | 42 | 1.9 | 86 | | | 22 mm |
| BMS-7932 | OP-2 | 50 | 7 | 43 | 1.9 | 86 | 1077 | 1156 | |
| BMS-7934 | OP-2 | 50 | 0 | 50 | 2.4 | 100 | 80 | 74 | 22 mm |
| BMS-7939 | OP-3 | 50 | 11 | 39 | 1.8 | 90 | 1188 | 1280 | 7 mm |
| BMS-7942 | OP-4 | 50 | 11 | 39 | 1.8 | 89 | 1432 | 1531 | 10 mm |
| BMS-7943 | OP-4 | 46 | 15 | 39 | 1.8 | 94 | 1575 | 1621 | 7 mm |
| BMS-7945 | OP-3 | 50 | 9 + 2¹ | 39 | 1.8 | 82 | 2302 | 2420 | 4 mm |
| BMS-7946 | OP-3 | 50 | 9 + 2² | 39 | 1.8 | 50 | 4316 | 4577 | 2 mm |

¹2% of water containing 70% CaCl₂
²9% water (no MgSO₄)s and 2% of water containing 70% CaCl₂

### Example 4

### Comparison of Aqueous-in-Oil Emulsion Composition Dilutions

Aqueous-in-oil emulsion compositions comprising various types and concentrations of thickeners and surfactants can be prepared and evaluated. For example, the 1-MCP concentrations and stability values of the various aqueous-in-oil emulsion compositions can be compared to determine preferred combinations of aqueous-in-oil emulsion compositions.

In the instant example, hydroxyethyl cellulose (Cellosize QP 100MH from Dow Chemicals) was used as the thickener. Various surfactants were evaluated, for example Tween 85, SMA 2625H, and SMA 3000H. Furthermore, the aqueous-in-oil emulsion compositions used in the instant example were prepared using a HAIP dispersion in water with magnesium sulfate (MgSO₄) (see, e.g., U.S. Pat. No. 8,691,728, the content of which is incorporated by reference in its entirety) at (50% w/w). The HAIP dispersion was prepared in Isopar V (50% w/w containing 6% PGPR and 0.75% Kraton G1702). The dilution was 1/59 of emulsion to water containing the different additives as shown in Table 3.

TABLE 3
Effect of thickener and surfactant on dispersion quality

| | | | 1-MCP in the | | |
|---|---|---|---|---|---|
| | HEC | Surfactant | headspace (ppm) | | Dispersion |
| Sample | (%) | (%) | 1 hour | 3 hour | quality¹ |
| BMS-7751-1 | 0.3 | Tween 85 (0.3) | 11,116 | 25,550 | 1 |
| BMS-7751-4 | None | Tween 85 (0.3) | 3,633 | 4,734 | 0 |
| BMS-7752-2 | 0.3 | SMA 2625H (0.3) | 2,571 | 3,300 | 2 |
| BMS-7757-2 | 0.3 | SMA 3000H (0.3) | 2787 | 2884 | 3 |
| BMS-7757-3 | 0.3 | SMA 3000H (0.5) | 962 | 1131 | 3 |
| BMS-7757-4 | 0.3 | SMA 3000H (0.8) | 1075 | 1371 | 3 |

¹A dispersion quality of 0 = none, 1 = medium, 2 = good, and 3 = excellent

As shown in Table 3, a combination of a thickener (HEC) and polymeric surfactant (e.g. SMA 3000H) provides a good dispersion of the aqueous-in-oil emulsion composition with low concentration of 1-MCP in the headspace.

For a comparison sample, a HAIP dispersion in water with magnesium sulfate (MgSO₄) can be prepared (see, e.g., U.S. Pat. No. 8,691,728, the content of which is incorporated by reference in its entirety). Comparison samples may contain 15-35% HAIP with 30-70% MgSO4.7H₂O.

To carry out dilution experiments with stirring, approximately 120 ml of tap water containing 0.3% HEC and 0.3% SMA 3000H can be added to a beaker and stirred with a magnetic stir bar. About 1 gram of the formulation can be added and stirred at 320 rpm for about 3 minutes. A 122 ml headspace bottle is then filled 50% full (˜60 grams) with the formulation and sealed with a mininert valve. The headspace can be sampled at specific time intervals and the 1-MCP concentration can be determined by GC. Comparisons of the aqueous-in-oil emulsion compositions are shown in Table 4.

TABLE 4
Dilutions of aqueous-in-oil emulsion compositions with stirring.

| | | | | 1-MCP | |
|---|---|---|---|---|---|
| | Aqueous- | 1-MCP | | concentration in | |
| | in-oil | Content | Dilution ratio | headspace (ppm) | |
| Example | Emulsion | (%) | Emulsion/water | 1 hour | 3 hour |
| 1 | Comparison | 1.2 | 1/119 | 13,111 | 22,027 |
| | sample | | | | |
| | (AF701) | | | | |
| 2 | BMS- | 1.2 | 1/119 | 513 | 474 |
| | 7909D | | | | |
| 3 | BMS-7912 | 1.5 | 1/149 | 2192 | 2096 |
| 4 | BMS-7917 | 1.2 | 1/119 | 1157 | 1599 |
| 5 | BMS-7918 | 1.4 | 1/119 | 1038 | 1437 |
| 6 | BMS-7922 | 1.6 | 1/119 | 1811 | 2642 |
| 7 | BMS-7932 | 1.9 | 1/119 | 1373 | 1819 |
| 8 | BMS-7934 | 2.4 | 1/119 | 3350 | 4899 |
| 9 | BMS-7939 | 1.8 | 1/119 | 2005 | 2916 |
| 10 | BMS7942 | 1.8 | 1/119 | 633 | 1196 |
| 11 | BMS-7943 | 1.8 | 1/119 | 580 | 1342 |
| 12 | BMS-7945 | 1.8 | 1/119 | 2517 | 3317 |
| 13 | BMS-7946 | 1.8 | 1/119 | 748 | 1136 |

### Example 5

### Comparison of Aqueous-in-Oil Emulsion Composition Dilutions Via Spraying

Generally, the procedure for carrying out dilution experiments with stirring and pumping and then spraying is as follows. About 877.0 g of tap water (22-25° C.) was placed in a 1 liter clear plastic Nalgene® bottle. While stirring the water magnetically at ˜400 rpm, about 2.7 g of hydroxyethyl cellulose (Cellosize QP 100MH, 0.3% w/w) was added to the water and allowed to stir for about 5 minutes. Thereafter, about 4.5 g of SMA 3000H (0.5% w/w) was added. Along with the magnetic stirring, the liquid was further stirred with a spatula and about 15.8 g of BMS 7939 was added (1:56 dilution). Manual stirring can then be discontinued and the bottle can be capped (sealed). Circulation, via a diaphragm pump, can be supplied at approximately 360 ml/min. Magnetic stirring can be continued during the circulation period. After about 1 hour, the head space of the bottle can be sampled for 1-MCP concentration (ppm).

A portion of the mixture (about 400 g) can be transferred, via the pump, to a 500 ml spray booth bottle. The liquid in this bottled can be sampled for 1-MCP concentration (%1-MCP) and used for application in the spray booth. The head space of the 500 g of material remaining in the Nalgene® bottle can be analyzed immediately after the removal of the 400 g sample. After an additional 1 hour of circulation, the head space can be analyzed again.

For spray booth evaluations, the bottle containing the 400 g sample can be attached to the spray booth nozzle and pressurized to about 40 psig. The material can be sprayed using an 18″ tray height, and a DG Teejet 8003VS nozzle. A 1 liter beaker sitting on the tray can recover a portion of the sprayed material. The contents of the beaker can be analyzed for 1-MCP concentration (% 1-MCP) and for head space (90% full, serum bottle) at one hour and also at three hours. The various dilution experiments with stirring and pumping and then spraying are shown in Table 5.

TABLE 5
Dilution experiments with stirring and pumping and then spraying

| | | | 1-MCP in the | |
|---|---|---|---|---|
| | | | headspace (ppm) | |
| | 1-MCP in | Dilution | After diluting | After |
| Sample | formulation (%) | ratio | and pumping | spraying |
| Comparison | 1.2 | 1:131 | 61,614 | 10,598 |
| (AF701) | | | | |
| WJZ 6691 | 0.6 | 1:59 | 1661 | 23,159 |
| WJZ 6828A | 1.4 | 1:94 | 1171 | 19,443 |
| WJZ 6829A | 1.6 | 1:111 | 1923 | 17,387 |
| WJZ 6830A | 1.8 | 1:122 | 656 | 15,824 |
| WJZ 6840A | 1.9 | 1:122 | 1205 | 20,867 |

Table 5 demonstrates that the aqueous-in-oil emulsion compositions generate low concentrations of 1-MCP in the headspace when diluted. Furthermore, when these dilutions are sprayed, a rapid mixing of the different phases results and large quantities of 1-MCP are generated.

### Example 6

### Compatibility of Aqueous-in-Oil Emulsion Composition with Other Ingredients

In the instant example, AF10081 is used as the exemplary aqueous-in-oil emulsion composition. AF10081 was prepared as described in Example-1 with 45% of OP-4, 12% of MgSO₄.7H₂O (44% containing 0.5% EDTA) and 43% of HAIP.

Studies have demonstrated that AF10081 can be easily diluted in a spray tank with <3000 ppm of 1-MCP in the headspace. The diluted milky solution can be readily sprayed, and the shear forces during spraying releases 1-MCP. Field trials have shown efficacy on apples. The instant example describes the compatibility of other active ingredients (e.g. Pristine®, DiPel®, and PoMaxa®) with AF10081 in the spray tank, as well as the spraying ability of the mixture.

As previously described, the preparation of aqueous-in-oil emulsions (AF10080/AF10081) with HAIP to provide formulations with high 1-MCP concentrations. The emulsions are chemically and physically stable and can be diluted with aqueous material (e.g., water) to provide sprayable formulations with low concentration of 1-MCP in the headspace. When sprayed, the aqueous-in-oil emulsion is destabilized and 1-MCP is released rapidly providing excellent biological efficacy. Since a number of other products are routinely sprayed during the period when a Harvista® application is done, the instant example was undertaken to determine if some of these ingredients can be mixed with the diluted AF10081 in the spray tank. After discussions with field personnel, three products (Pristine®, DiPel®, and PoMaxa®) were screened as models of routinely used materials in the field.

Compatibility of AF10081 (Batch BMS 7950) with Pristine®.

Pristine® fungicide is a leading fungicide used in specialty crops for the control of a wide spectrum of diseases as well as increased plant/fruit health. The label use rate for apples is 14.5 to 18.5 oz./acre, which equates to an average of 468 grams/acre. Assuming an application of 100 gal/acre, the concentration in the spray tank is about 0.12%. As described previously, a 1000 ml bottle (filled to 90%) was used to model a spray tank. The bottle is connected to a diaphragm pump (operating at 300 mil/min to mimic the turnover rate in a 300 gallon tank) and has a magnetic stirrer to mimic the paddle present in the spray tank.

To dilute the AF10081, Cellosize QP100 MH (0.3%) and SMA 3000H (0.5%) were utilized. The Cellosize was first added to the water followed by the SMA 3000H and then the AF10081 is added. The dilution ratio of AF10081 (2.0% 1-MCP) to water was 1:113. To determine if the order of addition of Pristine® impacts the physical and chemical stability of the mixture, Pristine was added at different times during the dilution of AF10081. Headspace was measured after mixing. Approximately 500 ml of the mixture was sprayed. The sprayed solution was collected and the headspace was measured again. The results are shown in Table 6.

TABLE 6
Mixing Pristine ® with AF10081 in a spray tank

| | Addition of | Headspace in | Headspace after | |
|---|---|---|---|---|
| Sample | Pristine ® | tank (ppm) | spraying (ppm) | Comments |
| WJZ 6860 | Added first to the | 3280 | 13,690 | Mixing is similar to |
| | water | | | experiments with no |
| | | | | Pristine. Spraying |
| | | | | ability is similar. |
| WJZ 6862 | Added after HEC and | 1159 | 16,560 | Mixing is similar to |
| | SMA | | | experiments with no |
| | | | | Pristine. Spraying |
| | | | | ability is similar. |
| WJZ 6865 | Added after AF10081 | 1227 | 13,148 | Mixing is similar to |
| | | | | experiments with no |
| | | | | Pristine. Spraying |
| | | | | ability is similar. |

Addition of Pristine® to the spray tank did not affect the dilution and mixing of AF10081. As the data in Table 1 indicate, the order of addition of Pristine® did not affect the final dispersion. The headspace concentration of 1-MCP was also not affected by the presence of Pristine®. All the samples sprayed well and released 1-MCP.

Compatibility of AF10081 (Batch BMS 7950) with PoMaxa®.

PoMaxa® is a formulation containing 3.1% of 1-Napthaleneacetic acid (NAA). NAA is used for thinning orchards to increase fruit size. The highest application rate of PoMaxa® is 20 ppm (8 fluid oz. of PoMaxa® in 100 gal) which equals to 0.6 g/l. The experiment was carried out as described above. PoMaxa® (0.06%) was added after the addition of AF10081. Results are shown in Table 7.

TABLE 7
Mixing PoMaxa ® with AF10081 in a spray tank

| | | Headspace | Headspace | |
|---|---|---|---|---|
| | Addition of | in tank | after spraying | |
| Sample | PoMaxa ® | (ppm) | (ppm) | Comments |
| WJZ 6866 | Added after | 2186 | 21,148 | Mixing is similar |
| | the addition | | | to experiments |
| | of AF10081 | | | with no additives. |
| | | | | Spraying ability |
| | | | | is similar. |

Addition of PoMaxa® to the spray tank did not affect the mixing and spraying of AF10081. The tank mixture had low concentration of 1-MCP in the headspace and after spraying the liquid showed good release of 1-MCP.

Compatibility of AF10081 (Batch BMS 7950) with DiPel®.

DiPel® contains a balanced blend of five bacterial protein toxins and a spore, which enhance efficacy and assist in resistance management. The use rate (DiPei® DF) for apple is 0.5-2 lb/acre. At the high use rate of 2 lb acre, this equates to 0.23% in the tank using a spray volume of 100 gals/acre. DiPel® DF (0.23%) was added after the addition of AF10081. Results are shown in Table 8.

TABLE 8
Mixing DiPel ® DF with AF10081 in a spray tank

| | | Headspace | Headspace | |
|---|---|---|---|---|
| | Addition of | in tank | after spraying | |
| Sample | DiPel ® DF | (ppm) | (ppm) | Comments |
| WJZ 6871 | Added after | 2495 | 18,044 | The dilution |
| | the addition | | | appeared to be |
| | of AF10081 | | | more viscous |
| | | | | and the spray |
| | | | | pattern was |
| | | | | reduced. |

Addition of DiPel® DF to the spray tank did not affect the mixing of AF10081. The dilution appeared more viscous and had a reduced spray pattern. Since a field sprayer has a powerful fan near the nozzles (to disperse the spray droplets), this will likely not be an issue.

The instant example indicates that a variety of commonly used agricultural products (e.g., Pristine®, DiPel®, and PoMaxa®) can be combined with AF10081 in the spray tank. The addition of these ingredients does not affect the stability or the spraying ability of the diluted dispersion. The headspace concentration of 1-MCP stays low (i.e., <3250 ppm, which is <30% of 13,000 ppm, the LEL of 1-MCP) and the sprayed solution releases 1-MCP rapidly.

We claim:

1. An aqueous-in-oil emulsion composition, comprising
(c) an oil phase comprising an oil medium, wherein the oil phase is between 25-70% by weight of the composition; and
(d) an aqueous phase comprising i) a cyclopropene molecular encapsulating agent complex and ii) water, wherein the aqueous phase is between 30-75% by weight of the composition; and
wherein the water is between 0.5-20% by weight of the composition.

2. The aqueous-in-oil emulsion composition of claim 1, wherein water is between about 0.5-6% by weight of the composition.

3. The aqueous-in-oil emulsion composition of claim 1, wherein the oil phase comprises a lipophilic emulsifier.

4. The aqueous-in-oil emulsion composition of claim 3, wherein the lipophilic emulsifier is selected from the group consisting of polyglycerol polyricinoleate, lecithin, sorbitan fatty esters, and combinations thereof.

5. The aqueous-in-oil emulsion composition of claim 3, wherein the lipophilic emulsifier is polyglycerol polyricinoleate.

6. The aqueous-in-oil emulsion composition of claim 1, wherein the oil phase comprises an oil soluble thickener.

7. The aqueous-in-oil emulsion composition of claim 6, wherein the oil soluble thickener is a styrene-ethylene-propylene block copolymer.

8. The aqueous-in-oil emulsion composition of claim 1, wherein the aqueous phase is substantially free of a salt.

9. The aqueous-in-oil emulsion composition of claim 8, wherein the salt is a non-deliquescent salt.

10. The aqueous-in-oil emulsion composition of claim 9, wherein the non-deliquescent salt comprises magnesium sulfate or ammonium sulfate.

11. The aqueous-in-oil emulsion composition of claim 1, wherein the aqueous phase comprises a salt.

12. The aqueous-in-oil emulsion composition of claim 11, wherein the salt is a non-deliquescent salt.

13. The aqueous-in-oil emulsion composition of claim 12, wherein the non-deliquescent salt comprises magnesium sulfate or ammonium sulfate.

14. An aqueous-in-oil-in-aqueous double emulsion composition, comprising:
(c) the aqueous-in-oil emulsion composition of claim 1; and
(d) a second aqueous phase;
wherein the by weight % does not consider the second aqueous phase.

15. The aqueous-in-oil-in-aqueous double emulsion composition of claim 14, wherein the second aqueous phase comprises a hydrophilic emulsifier.

16. The aqueous-in-oil-in-aqueous double emulsion composition of claim 14, wherein the hydrophilic emulsifier is selected from the group consisting of poly(vinyl alcohol), poly(acrylic acid), poly(acrylamide), sodium caseinate, whey protein isolate (WPI), polysaccharide, copolymers of ethylene glycol and propylene glycol (e.g. Pluronic), polyoxyethylene derivatives of sorbitan monolaureate (e.g. polysorbate 20, polysorbate 80) and combinations thereof.

17. The aqueous-in-oil-in-aqueous double emulsion composition of claim 14, wherein the hydrophilic emulsifier is hydroxyethyl cellulose.

18. The aqueous-in-oil-in-aqueous double emulsion composition of claim 14, wherein the second aqueous phase comprises a surfactant.

19. The aqueous-in-oil-in-aqueous double emulsion composition of claim 18, wherein the surfactant has a hydrophilic/lipophilic balance (HLB) of between 10-15.

20. The aqueous-in-oil-in-aqueous double emulsion composition of claim 18, wherein the surfactant is an aqueous salt solution of a styrene-maleic anhydride copolymer.
